(19) United States
(12) Patent Application Publication
(10) Pub. No.: US 2005/0178567 A1
(43) Pub. Date: Aug. 18, 2005

(54) Soil cultivating device

(75) Inventor: Georg Wiedenmann, Rammingen (DE)

Correspondence Address: STEVENS DAVIS MILLER & MOSHER, LLP, 1615 L STREET, NW, SUITE 850, WASHINGTON, DC, 20036, US

(73) Assignee: Wiedenmann GmbH, Rammingen (DE)

(21) Appl. No.: 10/512,983

(22) PCT Filed: May 13, 2003
(86) PCT No.: PCT/DE03/01543

(30) Foreign Application Priority Data
May 15, 2002 (DE) 102 21 600.2

(51) Int. Cl. A01B 45/02

(52) U.S. Cl. 172/21

(57) ABSTRACT

The invention relates to soil cultivating device (1) which can be driven or connected to a vehicle. Said soil cultivating device comprises tools (3) which are guided in the direction of the soil that is to be cultivated and a rotatably driven crankshaft (7) actuating said tools (3). In order to facilitate production and maintenance while ensuring a faster working speed and improving handleability and possibly also reducing the requirements to be met by the traction vehicle or supporting vehicle, the crankshaft (7) is driven from at least one lateral end area of the extension thereof, which is located perpendicular to the direction of motion.

The invention relates to soil cultivating device having the features as set forth in the preamble of the attached claim 1.

Particularly, the invention relates to a travelling or vehicle-hitchable soil cultivating device having tines actuated, especially reciprocated, in the direction of the soil to be cultivated by a central crankshaft powered rotatingly by a power take-off from the engine of a pulling or mounting vehicle. More particularly, the invention relates to a cultivating device for deeply loosening soil, below turf for example, in other words a turf aerator, having a linearly height-adjustable chassis mounting a series of soil-piercing tools oriented approximately perpendicular to the direction of travel, each of which is guided by means of a link member in an adjustable orientation to the ground for implementing aeration by means of the crank drive in a roughly vertical plane running in the direction of travel in being swivably held spring-mounted against a stop, the link member being pivot mounted at one end fixed to the chassis and at the other end at the tool or a holder securely mounting the latter.

Devices of this kind are known, for example, from EP 0 452 449 B1, EP 1 040 741, DE 200 15 504 U, DE 200 20 018 U and EP 1 210 853 A1 and in operation in a wealth of variants.

These known machines already work with differing working widths and/or piercing depths of the tools, the angle of which can be varied centrally adjusted. The prior art documents as cited above, are expressly incorporated herein by reference since the aspects as described in the following may find application in all of these known machine types.

Hitherto the here discussed devices have been powered by the power take-off of the pulling or supporting vehicle. This has been done via a central transmission working on the crankshaft; in this arrangement a transfer gearbox is arranged centrally on the crankshaft so that transmission and crankshaft form a single unit. As result, this unit comprising transmission, its casing and crankshaft was a separate design causing a more complicated production.

These soil cultivating device have a good track record, especially in professional lawn care. The known machines, however, still place relatively high demands on the pulling or mounting or supporting vehicle. In addition to corresponding load capacity, size and power, some of them even require a crawling speed of less than 5 km/h.

The object of the invention is to configure such cultivators for enhanced economy and handling in operation even on smaller working areas. In addition to expanding availability in the direction of smaller machines, a further object of the invention is to render the machines relatively fast. For example, for safe standing or maneuverability it is also desirable to arrange for the cultivators or their center of gravity to be as near as possible to the pulling or mounting vehicle. This, however, is a problem because of the drive. Hitherto such a turf aerator was powered as a rule from the power take-off of the traction vehicle deriving from the crankshaft of the engine—without translation, in other words in a ratio of 1:1—a speed roughly in the range of 500 to 600 rpm and correspondingly more for higher engine speeds. It is also an object of the invention to use tractors requiring no crawling speed (4.2 km/h).

Fast working necessitates, among other things, low weight. This, in turn, necessitates short transmission distances. In addition to minimizing dynamic loading a compact structure is needed, whereby the one requirement may supplement the other.

Another object of the present invention is thus to configure cultivators of the aforementioned kind as well as similar cultivators featuring centrally actuated tools more compact for faster working.

For this purpose a cultivator having the features as set forth in in the attached claim 1 is proposed. Advantageous aspects read from the sub-claims.

Particularly preferred is the application of the invention to known soil aerators as mentioned at the outset whose tools “break” the soil, i.e. not merely executing piercing action but also an angular motion in enhancing the cavitation of the soil.

In one aspect of the invention it is provided for that the crankshaft is powered by at least one side end portion of its extent transversely to the direction of travel. Powering the crankshaft from the side now makes it possible to realize a drive, particularly a pulley drive, more particularly an encapsulated belt drive outside of the working area and thus away from becoming dirty. Configuring the powering principle in this way simplifies the design, diminishes malfunctioning whilst facilitating maintenance of the crankshaft drive. Now, because of facilitated access, direct use can be made also of non-positive drives such as vee or other, for instance ribbed, belt drives. Changing the belt as may be necessitates in the case of maintenance is now no problem when the crankshaft drive is located at the end portion of the crankshaft and/or cultivator.

A basic idea of the present invention involves a basic change in powering the crankshaft as compared to prior art crankshaft drive arrangements in that the drive is designed more compact in permitting the cultivator and the pulling or mounting vehicle to be located closer together whilst being compatible with simple, readily availability drive elements.

In one advantageous aspect it is provided for that the crankshaft is powered over the width of the traction vehicle or aerator on at least one of the two side end portions. When powered on both sides the crankshaft may be configured full-length over the width or also separated in parts.

The drive is preferably taken from one power take-off to a transfer gearbox arranged aft of the crankshaft as viewed from the vehicle and leading from the middle to transmission wheels or gears on both sides. The side drive unit featuring these transmission wheel or gears is preferably configured as a pulley drive. The pulley drive can have a chain or ribbed belts as pulling transmission element. Preferably, however, vee belts are employed which as non-positive transmission elements behave like slip clutches. This is of advantage when problems are encountered in aeration, for instance when the tools encounter stones or the like.

It is, however, just as possible to make use of separate slip clutches in the power train as a precaution against obstacles otherwise disruptive to smooth operation. At a piercing depth of approximately 20 cm the crankshaft works preferably directly on the tool holder, without this being any limitation significant for the invention.

In accordance with another basic idea of the invention by positioning the transfer gearbox aft of the crankshaft as viewed from the vehicle with a corresponding power take-off connection passing through the cultivator, the space required between the tool holder and the traction vehicle is rendered correspondingly small. Then, the power take-off connection can be positioned aft of the face of the aerator facing the vehicle. This now makes it possible to correspondingly reduce the dynamic loading in transmission to the tool holder and to increase the working speed of the tools. The working speed can here approach the rotary speeds dictated by the driving vehicle, and one can provide translation ratios as small as possible. Ideally, a translation ratio of 1:1 between the crankshaft of the driving vehicle and the crankshaft of the cultivator can be achieved.

As a rule, the here discussed soil cultivating device are arranged at the rear or behind the vehicle; the position indications used hitherto, (particularly aft or forwards “in the direction of travel; front”)are related to this usual mounting arrangement. However, the ideas of the invention and the advantageous aspects or embodiments thereof are just as applicable to other arrangements when suitably accommodated.

An example embodiment of the soil cultivating device equipped in accordance with the invention will now be detained with reference to the attached drawings in which:

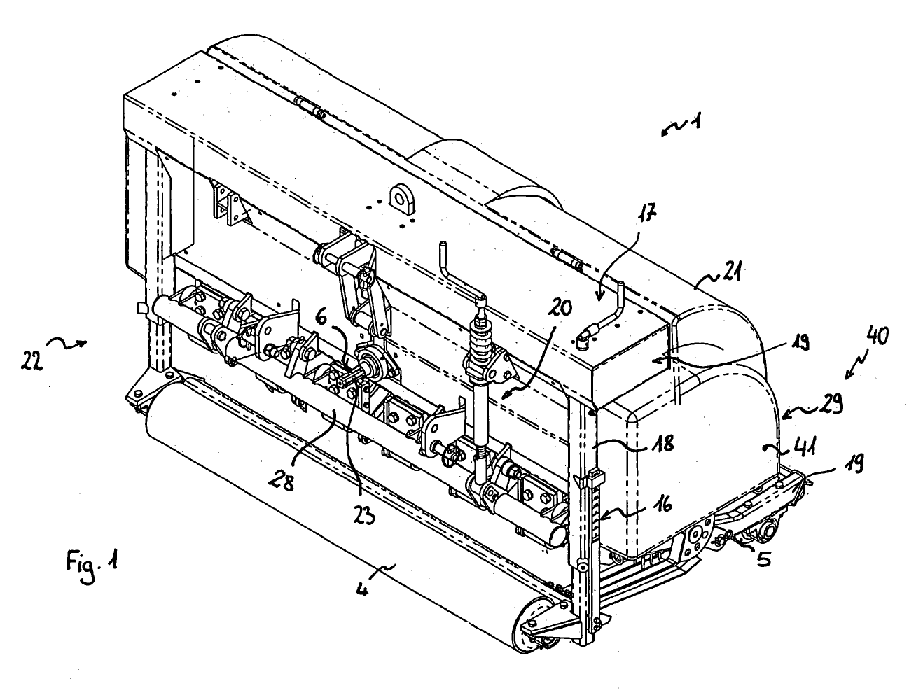

FIG. 1 is perspective view of a soil cultivating device of the pulling, mounting, or supporting vehicle;

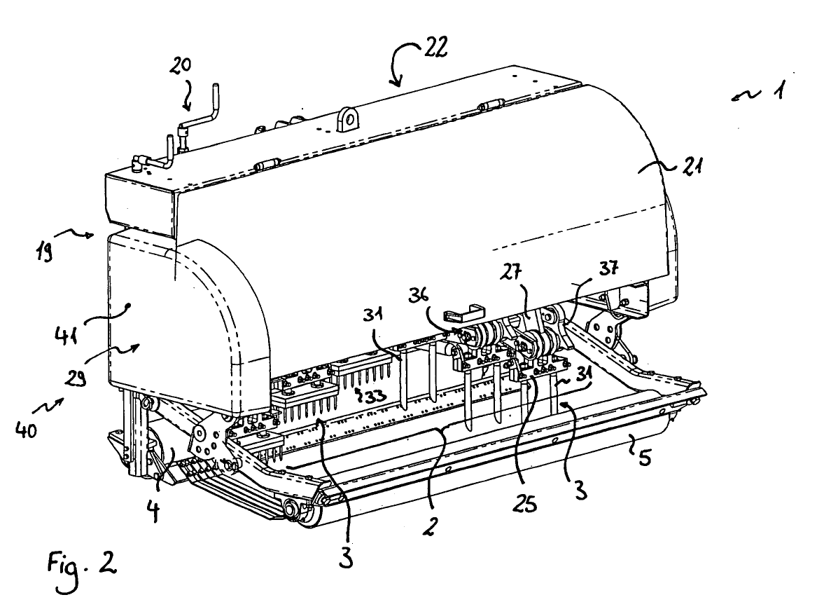

FIG. 2 is likewise a perspective view of the device as seen in a direction to the pulling or mounting vehicle from one side;

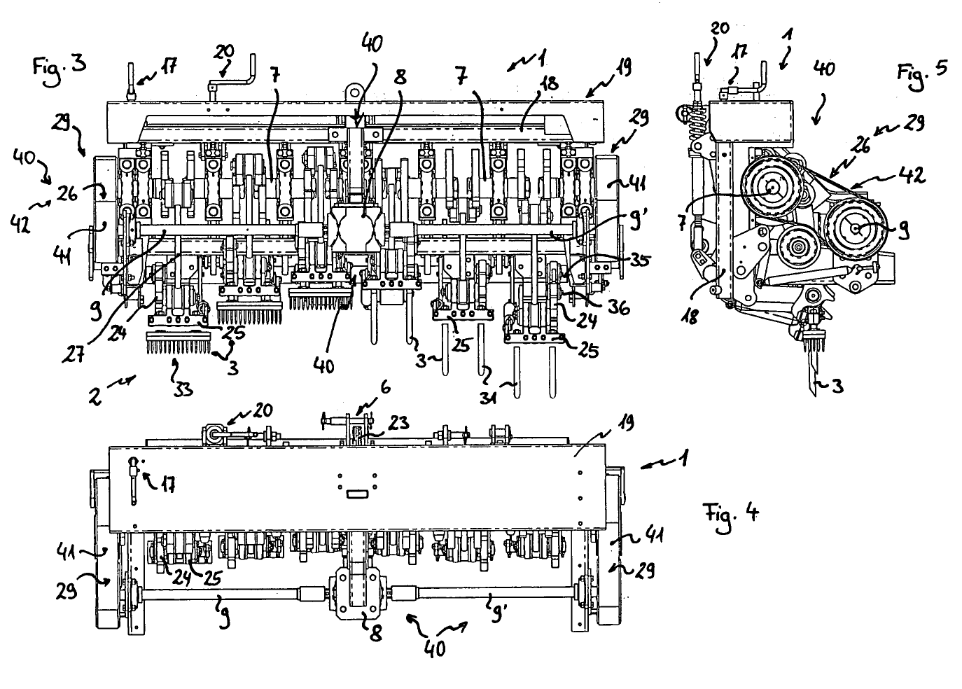

FIG. 3 is a rear view of the soil cultivating device—seen in the direction towards the vehicle—with the cover omitted;

FIG. 4 is a side view of the soil cultivating device with the cover omitted;

FIG. 5 is a plan view of the soil cultivating device with the cover omitted;

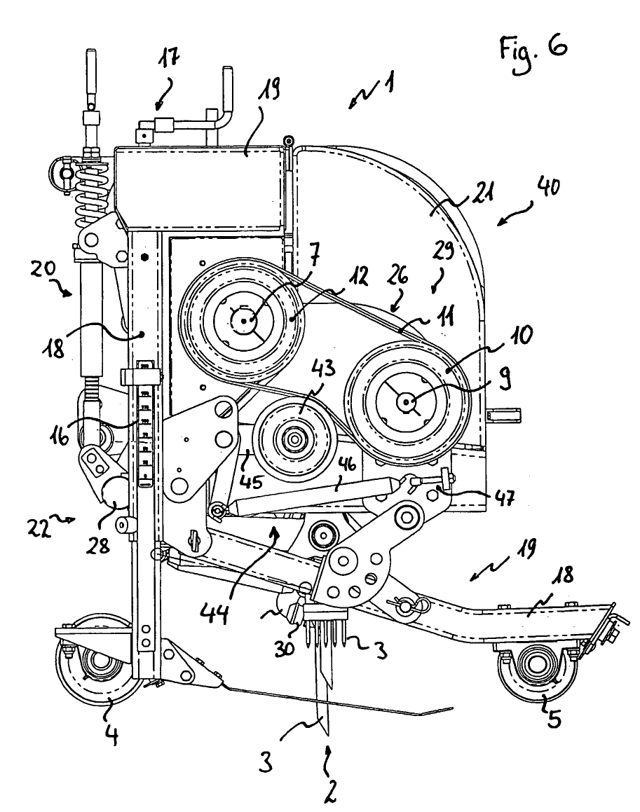

FIG. 6, 7 are side views of the soil cultivating device by way of example;

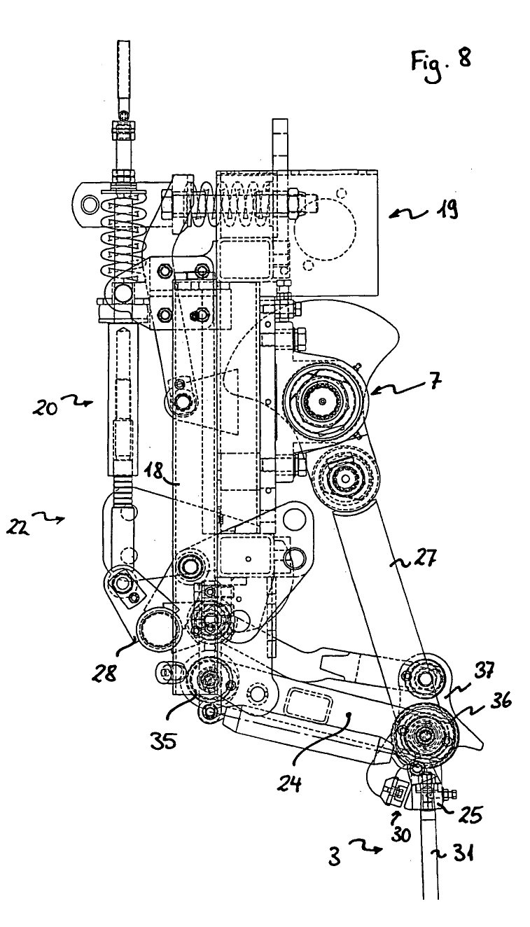

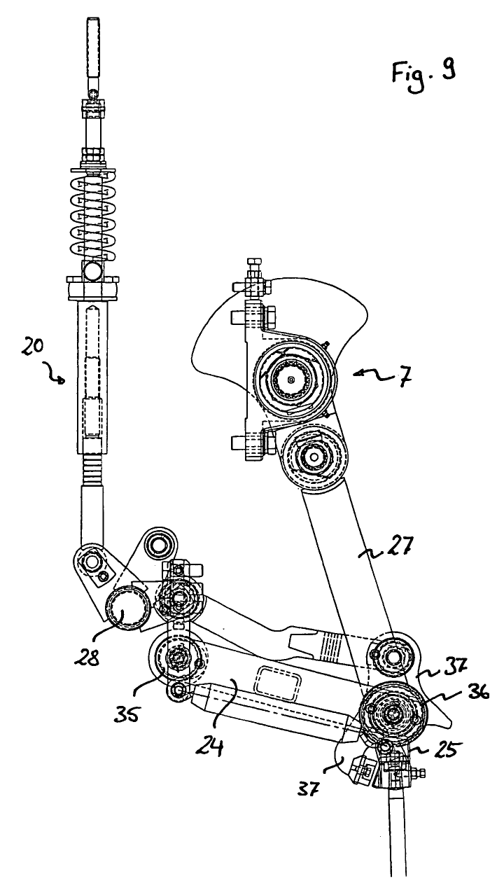

FIG. 8 is a side view of a drive mechanism for driving one of the tools of the soil cultivating device; and

FIG. 9 is a side view of the moving parts of the drive mechanism as shown in FIG. 8.

Referring now to FIG. 1 there is illustrated a soil cultivating device, identified in all by the reference numeral 1, for providing aeration openings into the soil. The soil cultivating device 1 is designed for rear mounting or hitching to a vehicle (not shown) with a power take-off, such as particularly a tractor. The soil cultivating device features for this purpose a linearly height-adjustable chassis 19. The soil cultivating device 1 is enclosed by a cover 21 at the rear, as viewed from the vehicle, and comprises roller-like supports 4 and 5 contacting the ground to be worked. The chassis 19 has a frame 18 which is height-adjustable by means of height-adjuster 17 with a scale 16 for indicating the working (piercing) depth relative to the rollers, which are in rolling, large surface contact with the ground of the support 4, 5.

Referring now to FIGS. 2 and 3 there is illustrated how the soil cultivating device 1 includes a group or a set, identified in all by the reference numeral 2, of tools 3 arranged side by side in the width direction of the soil cultivating device 1. By way of example different tine sizes usable in the device are illustrated in the attached FIGS. There are shown large tines 31 each securable in pairs to a tine holder 25 and brush like tine groups 33 with a multitude of small tines on a mounting plate likewise securable to the tine holder 25. Preferably only one type of tine in the complete set or group 2 is used. The tines 3 serve to aerate the soil by piercing, preferably together with an angled motion to loosen the soil before being retracted.

As evident from FIG. 1 there is provided at the side facing the vehicle, i.e. in this case the front 22, the stubs 23 of a power take-off 6, by means of which a crankshaft 7 extending mainly transversely to the direction of travel (see FIG. 3) is powered. By rotation of the crankshaft 7, the tines 3 are moved up and down for implementing piercing. The tines 3 are adjustable by means of a central adjuster 20 as shown in FIG. 1.

Referring now to FIGS. 8 and 9 there is illustrated best the mechanism for powering the piercing acton. The tines 3 are pivot mounted on link members 24. The tines seat on holders in the form of the tine holders 25 which are spring-loaded to pivot against a stop 30. The link members 24 are pivoted with a first bearing 35 on the chassis 19. At their free end the link members feature a second bearing 36 with which each tine holder 25 and an adjusting lever 37 comprising the stop 30 are pivot-mounted. Via a central adjusting shaft 28 the position of the adjusting lever 37 and thus the setting angle of all stops 30 and in turn the piercing angle for the tines 3 of the set 2 as a whole can be set by means of the adjuster 20. The link members 24 are connected to the crankshaft 7 for moving up and down via connecting rods 27.

For a more detained explanation of the basic configuration and function of the soil culltivating device 1 and its components, particularly as regards the adjuster 20 reference is made to the aforementioned patent documents EP 0 452 449 B1, EP 1 040 7 41, DE 200 15 504 U, DE 200 20 018 U and EP 1 210 853 A1 incorporated herein by reference to form a part of the disclosure.

Detailled in the following is a drive 40 connecting the crankshaft 7 to the power take-off 6 for transmission. As evident from FIGS. 3 to 7 the power take-off 6 of the crankshaft 7 passes through the soil culltivating device 1 practically full-length in the direction of travel. More particularly, the power take-off 6 transmitts the driving force beyond the crankshaft 7 which can thus be positioned nearer to the vehicle as compared to known devices.

According to FIG. 5, the power take-off 6 is connected by means of a shaft (not shown) to a transfer box or transfer gearbox 8 which is connected on the right and left by output shafts 9, 9′. Here, the transfer gearbox 8 with the output shafts 9, 9′ is arranged remotely or behind from the crankshaft 7 as viewed from the vehicle. Each of the output shafts 9, 9′ is connected to a side drive unit 29. Each drive unit 29 is accommodated in a housing 41 with a removable cover preventing dirt ingress and finger injury.

Referring now to FIGS. 4 to 7 there is illustrated a drive unit 29 arranged at the side of the soil culltivating device facing the crankshaft 7, shown here without the housing 41. The drive unit 29 comprises a drawing transmission or pulley drive 42 for transmitting the driving force to the crankshaft 7. In the example as shown each of the output shafts 9, 9′ is connected by a vee belt drive 26 to the crankshaft 7. For this purpose the output shafts 9, 9′ are connected by their free ends to pulleys 10. Via vee belts 11 the pulleys 10 connect drive pulleys 12 connecting the crankshaft 7 endwise non-rotatively.

This results in the drive being transmitted in a train from the power take-off 6 connectable to the pulling or mounting vehicle via the transfer gearbox 8 and two endwise, downswept output shafts 9, 9′ arranged to the rear of the crankshaft 7 as viewed in the forwards direction of travel to pulley 10, 12 arranged at the sides. It is this arrangement that now makes it possible to position the soil culltivating device very near to the vehicle. Indeed, the power take-off 6 can even be relocated back in the soil culltivating device region as indicated in FIG. 1.

The transmission from the the two output shafts 9, 9′ downswept roughly perpendicular to the direction of travel (although skew arrangements are just as possible) on both sides as viewed from the transfer gearbox 8 to the crankshaft 7 can also be made positive, e.g. by means of ribbed belts, chain or the like or also by means of gearwheels. Preferably the output shafts 9, 9′ and the face ends of the crankshaft 7 are connected, however, by a non-positive connection, for example by the vee belt drive 26 as shown here. The resulting non-positive drive is basically suitably to act as a slip clutch when the tines 3 encounter obstacles to their motion. Another possibility would be to install an extra slip clutch permitting better adjustment in the drive link.

The drive unit 29 comprises a tensioner 44 for tensioning the drawing or pulling element belting of the drawing transmission or pulley drive 42. In this case, the tensioner is formed by a takeup pulley 43 which pretensions the vee belt. The takeup pulley 43 is rotatably mounted on a movable support 45. The support 45 is biased by a spring 46 in the pretensioning direction. The bias of the spring 46 can be varied by an adjuster, in this case in the form of a tensioning screw 47. Setting the bias achieves a setting for the force threshold of the slip clutch. In this case the support 45 takes the form of a pivot lever. Moving the support 45 also enables the vee belt 11 to be released and removed when requiring replacement.

In the example aspect as shown, the pulleys 10 are the same size as the drive pulleys 12 so that the pulley drive has approximately a ratio of 1:1. It is easy to achieve any other transmission ratio by suitably sizing pulleys 10 and 12.

The crankshaft 7 may be formed in one piece or built split. In a split crank-shaft 7 both crankshaft parts are powered via separate drive means, in this case in the form of separate vee belt drives 26, each end-mounted at the outer side of the soil culltivating device.

The drive 40 described is compatible with all soil cultivating device concerned, particularly with all soil cultivating device as known from EP 0 452 449 B1, EP 1 040 7 41, DE 200 15 504 U, DE 200 20 018 U and EP 1 210 853 A1. A near vehicle arrangement is achieved and particularly also a high operation speed enhancing the economic application of such cultivating device. This arrangement now makes it possible to power the soil cultivating device tines without deriving a change in the translation ratio from the power take-off connection or crankshaft of the pulling or mounting vehicle, resulting in not only high working speed but also less complexity in production.

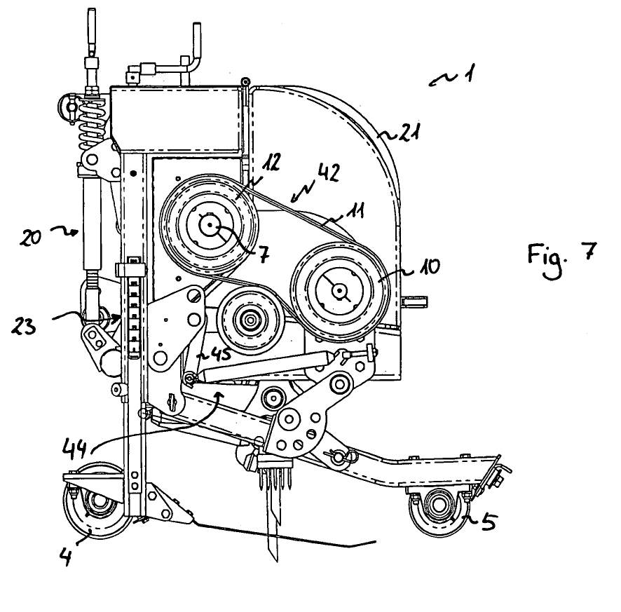

This is why, in a preferred embodiment, it is also possible that the connecting rods 27 extending from and actuated by the crankshaft 7 work directly on the connecting portion of the tines 3 and tine holders 25, respectively. In accordance with this arrangement, as evident from FIGS. 7 and 8, each connecting rod 27 is pivoted at that of its ends, which is nearby the tine, via the second bearing 36 or coaxially to the second bearing 36 at the link member 24 or tine holder 25. Hitherto these connecting rods were pivoted in the region of the link between the fixed chassis mount and the mount for the tines or tine holders. However, such a travel ratio as associated with these prior art pivoting arrangements is, of course, also not excluded by the system in accordance with the invention as described above.

### LIST OF REFERENCE SIGNS

1 soil cultivating device

2 group or sequence of tools

3 tine

4 roller-like support

5 roller-like support

6 power take-off

7 crankshaft

8 transfer gearbox

9, 9′ output shafts

10 pulleys

11 vee belt(s)

12 drive pulleys

16 scale

17 height-adjuster

18 frame

19 chassis

20 central adjuster

21 cover

22 front

23 stubs

24 link members

25 holder (tool holder)

26 vee belt drive

27 connecting rods

28 central adjusting shaft

29 drive unit

30 stop

31 tines, large

33 tine clusters

35 first bearing, not movable in position relative to the chassis

36 second bearing

37 adjusting lever

40 crankshaft drive

41 housing

42 pulley drive

43 takeup pulley

44 tensioner

45 support

46 spring

47 tensioning screw

1. A traveling or vehicle-hitchable soil cultivating device having tools actuated in the direction towards the soil to be cultivated and a crankshaft powered rotatingly for actuating the tools wherein the crankshaft is powered from at at least one side end portion of its extent transversely to the direction of travel.

2. The soil cultivating device as set forth in claim 1, wherein
the tools are guided to move up and down,
the crankshaft is powered and/or arranged centrally and/or
the crankshaft can be rotatively powered as picked off from the engine of a pulling or mounting vehicle.

3. The soil cultivating device as set forth in claim 1 configured as a soil aerator, comprising
a height-adjustable chassis, particularly a linearly height-adjustable chassis; and
a series of soil-piercing tools oriented mainly perpendicular to the direction of travel.

4. The soil cultivating device as set forth in claim 3, wherein each tool is guided by means of a link member, in an orientation towards the ground for implementing piercing operation driven by means of the crankshaft and is held swivably in a roughly vertical plane in the direction of travel and spring-mounted against a stop, the link member being pivot mounted at one end in a bearing fixed to the chassis and at the other end at the piercing tool or a holder securely mounting the latter.

5. The soil cultivating device as set forth in claim 1, wherein the crankshaft is powered from both sides and is split.

6. A powered or vehicle-hitchable soil cultivating device in accordance with claim 1, having tools actuated in the direction towards the soil to be cultivated and a crankshaft powered rotatingly for actuating the tools, wherein at least one drive unit arranged in a side end portion of the soil cultivating device for powering the crankshaft.

7. The soil cultivating device as set forth in claim 6, wherein the drive unit for powering the crankshaft comprises a pulley drive.

8. A vehicle-hitchable soil cultivating device in accordance with claim 1, having tools actuated, in the direction towards the soil to be cultivated and a crankshaft powered rotatingly for actuating the tools, characterized by a transmission device for transmitting a moving force introduced centrally into the soil cultivating device to the crankshaft the transmission device being arranged beyond or remote from the crankshaft as viewed from the vehicle.

9. The soil cultivating device as set forth in claim 1 wherein a power take-off for connecting the power of an engine of a pulling or mounting vehicle is arranged to extend in the direction of travel into and through the soil cultivating device and acts via a transfer gearbox and at least one output shaft down-swept to the side thereof to at least one first transmission wheel connected via a belt or like transmission element to at least one second transmission wheel mounted non-rotatively on the side of the crankshaft for corresponding transmission.

10. The soil cultivating device as set forth in claim 1 wherein a connection at the soil cultivating device for connecting a power take-off of the pulling or mounting vehicle is positioned aft of the cultivator front facing the vehicle.

11. The soil cultivating device as set forth in claim 3, wherein each tool is guided by means of a link member, in an adjustable orientation towards the ground for implementing piercing operation driven by means of the crankshaft and is held swivably in a roughly vertical plane in the direction of travel and spring-mounted against a stop, the link member being pivot mounted at one end in a bearing fixed to the chassis and at the other end at the piercing tool or a holder securely mounting the latter.

12. The soil cultivating device as set forth in claim 1, wherein the crankshaft is powered from both sides and is split roughly in the middle.

13. The soil cultivating device as set forth in claim 6, wherein the drive unit for powering the crankshaft comprises an encapsulated pulley drive.

14. The soil cultivating device as set forth in claim 6, wherein the drive unit for powering the crankshaft comprises a belt drive.

15. A powered or vehicle-hitchable soil cultivating device, having tools actuated in the direction towards the soil to be cultivated and a crankshaft powered rotatingly for actuating the tools, wherein at least one drive unit arranged in a side end portion of the soil cultivating device for powering the crankshaft.

16. The soil cultivating device as set forth in claim 15, wherein the drive unit for powering the crankshaft comprises an encapsulated pulley drive.

17. The soil cultivating device as set forth in claim 15, wherein the drive unit for powering the crankshaft comprises a belt drive.

18. A vehicle-hitchable soil cultivating device, having tools actuated, in the direction towards the soil to be cultivated and a crankshaft powered rotatingly for actuating the tools, and a transmission device for transmitting a moving force introduced centrally into the soil cultivating device to the crankshaft the transmission device being arranged beyond or remote from the crankshaft as viewed from the vehicle.

19. The soil cultivating device as set forth in claim 18, wherein a power take-off for connecting the power of an engine of a pulling or mounting vehicle is arranged to extend in the direction of travel into and through the soil cultivating device and acts via a transfer gearbox and at least one output shaft down-swept to the side thereof to at least one first transmission wheel connected via a belt or like transmission element to at least one second transmission wheel mounted non-rotatively on the side of the crankshaft for corresponding transmission.

20. The soil cultivating device as set forth in claim 18, wherein a connection at the soil cultivating device for connecting a power take-off of the pulling or mounting vehicle is positioned aft of the cultivator front facing the vehicle.
